(19) United States
(12) Patent Application Publication
(10) Pub. No.: US 2009/0125342 A1
(43) Pub. Date: May 14, 2009

(54) DISPOSITION METHOD AND DISPOSITION MODULE

(75) Inventor: Thomas Reichhart, ALDENHOVEN (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: HIFLEX SOFTWARE GESMBH, WIEN (AT)

(21) Appl. No.: 11/813,800

(22) PCT Filed: Dec. 2, 2005
(86) PCT No.: PCT/EP05/12896

§ 371 Date: Jul. 12, 2007

(30) Foreign Application Priority Data
Jan. 17, 2005 (DE) 10 2005 002 299.5

(51) Int. Cl. G06F 17/50

(52) U.S. Cl. 705/7

(57) ABSTRACT

A method for the disposition of process steps in the context of jobs is disclosed, which are issued by a management information system, and executed on at least one execution system, wherein the jobs are defined by a calculation module in the context of the management information system, allocated to volume- and time resources of the execution systems through a disposition module, and transmitted to the execution systems in Job Definition Format.

In order to facilitate the handling of a large number of process steps, it is suggested that process steps are combined into groups in the disposition module.

The invention relates to a method for the disposition of process steps associated with jobs, which are issued by a management information system, and which are executed on at least one execution system, wherein the jobs are defined by a calculation module within the management information system, allocated time and volume resources of the executing system through a disposition module, and transmitted to the execution systems in Job Definition Format.

The decision and the disposition over the time or the date, duration and volume, use of resources (also: “production factors”), in particular, labor, equipment, and materials for executing jobs, is called disposition. The basic goal of disposition is capacity planning. A disposition method has to schedule incoming jobs and allocate them to the performance locations of the disposition area, and steer and regulate materials flows and product inventories, so that all jobs can be reliably delivered at the desired delivery date at minimum cost. Prerequisites for the cost optimized disposition are predictability and knowledge of the costs, which are influenced by the disposition.

The Job Definition Format “JDF” (and the Job Messaging Format “JMF”, as a subset of JDF) are generally known data formats, which have been developed and are being maintained by the consortium “International Cooperation for the Integration of Processes in Prepress, Press and Postpress” (“CIP4-Consortium”, www.cip4.org). The development of JDF is based on the objective to standardize the communication between print shop, designer, advertising agency, customer for printed matters, and sub vendors of contractors in the context of a networked graphic production for all production options and eventualities in a flexible manner and without restrictions.

JDF is based on the Extensible Markup Language “XML”, a META language, which is also generally known and developed by the World Wide Web Consortium (“W3C”, www.w3.org) for defining document types and, according to the intentions of the CIP4-Consortium, and is to serve as a standard data format for describing processes and products, not only in all production areas of a networked print shop, in particular in sales, job costing, and order processing, production planning and control in the regular production, in preproduction, print, print post processing, and shipping, in the cross sectional areas, materials and warehouse management, financial and payroll accounting, controlling, cost accounting, and quality assurance.

Through vertical integration of data, on the one hand of the production process, and on the other hand of the accounting sectors, JDF shall facilitate a standardized documentation of the relevant target and actual data, and seamless production control. In particular, a JDF job shall only be described once in one form, which all process participants understand, also in external communications with customers and subcontractors and their execution systems in the man-machine and machine-machine communication over all language and platform boundaries.

Since, according to the philosophy of the CIP4, the entire management of a job is to be controlled and documented through a comprehensive JDF file, any process step is described in this file in as much detail, as it is required for the execution on the respective execution system.

Already the allocation of process steps to an execution system, through a JDF file, therefore has to balance conflicting requirements: while the JDF file depicts each process step in detail, the disposition only considers process steps, which are relevant with respect to capacities (from a duration, date, and volume point of view). An additional conflict of requirements occurs, when a process step is not calculated with respect to its capacity, thus when it is not completely defined from a disposition point of view, but constitutes a milestone in the context of the execution planning of a job.

Object

It is the object of the invention to propose a method as mentioned above, in which the handling of a large number of process steps is facilitated.

Solution

According to the invention, it is being proposed that process steps are combined into groups in the disposition module.

At least at first glance, it appeared to be useful and obvious to use the same internal JDF data structures for the disposition module, as for the communication of the disposition module with the connected execution systems. According to the JDF specification, single process steps are represented by XML nodes, which are defined by input and output variables respectively. The input variables of a node are thus the resources required for the process step, and the parameters controlling it. The output variables of the node are the resources produced by the process step, which, in turn, can be input variables of one or several other nodes, or resources required in other process steps. The workflow of a job, thus the sequence of particular process steps, is described in a JDF data structure only indirectly through the input- and output variables, defined for each node. Another linking of process steps is explicitly undesirable according to the basic concept of the JDF specification, in order to maintain the flexibility of this concept for describing a plurality of different projects and project status (JDF Specification, Release May 12, 2004, www.cip4.org/documents/jdf specifications/).

Thus, the grouping of process steps, according to the invention, explicitly contradicts the JDF concept, and is thus not possible with the use of pure JDF data structures. The method according to the invention thus requires the conversion of an internal data structure to the JDF data structures to be transmitted to the execution systems.

Through the possibility of grouping process steps, the method according to the invention, facilitates in particular the handling of a large number of process steps. Instead of the disposition of a plurality of single process steps, according to the inventive method, a group of process steps can be disposed like a single process step. Thus the start time and the predecessors of the first process step of the group are being perceived as start time and predecessor, or completion time and successor of the last process step of the group as end time and successor of the group, and the sum of the requirements with respect to labor, processing times, and material over all process steps of the group.

During a disposition of a group of process steps, only the start- and end times, predecessors, successors, and requirements of the group are being visibly managed. The remaining quasi “internal” beginning and end times, predecessors, successors, and requirements of the process steps of the group are automatically adjusted for controlling the execution systems, but they are not editable by themselves.

in a preferred embodiment of the method according to the invention, groups are dissolved in the disposition module, when required, and the included process steps (or subgroups of process steps) are disposed one by one. Thus, the disposition of a job can react flexibly, in particular to the changes of the job, or also to the problems occurring, when executing the job, like defects in execution systems, or erroneous productions of products of particular process steps.

In the context of the method according to the invention, based on the predefined rules, groups can be established in the context of a job, and process steps of groups can be sorted. In the context of a job, a group can comprise process steps, following directly upon each other. Through the automatic generation of a proposal for a grouping of all respective process steps following each other directly without branching off, and without additional external dependencies, the disposition of a job is simplified significantly.

A proposal for a grouping and for the sequence of the process steps in the group can be automatically generated, depending from any attribute of a process step, with the assistance of a regular expression, or a numerical comparison, or a Boole link of regular expressions or numerical comparisons. Based on predefined rules, a proposal for a grouping can be produced automatically, directly when loading the files into the disposition module, or upon request of from a user.

On the other hand, in the context of a method, according to the invention, a group can also comprise similar process steps, which can also be associated with different jobs. Such a grouping of similar process steps can, for example, significantly simplify the disposition for a resource that is only available temporarily, e.g. an employee with restricted work hours.

In a particularly flexible disposition module according to a method according to the invention, groups can be combined. The multistage combination of process steps particularly simplifies a cascading disposition, in particular in very large jobs, e.g. initially of the entire job in a coarse manner, subsequently of the defined groups, and only at last of the particular process steps.

In an advantageous embodiment of a method according to the invention, process steps can be allocated to resources without capacity in the disposition module. Resources are designated as being without capacity in the calculation, whose time, labor or materials expenditure is not allocated specifically to a process step, or which are not coordinated with respect to timing in the sense of a “to-do list”. For example up to six hundred print plates per shift can be exposed on a plate exposition machine. The cost for exposing a particular plate in the context of a job is so small that it is often calculated as a lump-sum in a simplified manner in a known calculation method. The detailed tracing of the resource use related to the particular jobs does not make business sense in the case of the plate exposition machine.

The disposition of resources without capacity contradicts the basic idea of the disposition as capacity planning means, and is, therefore, not provided in known disposition methods. On the other hand, process steps on resources without capacity in the sense of a workflow can be necessary predecessors of other process steps. For example, information with respect to the question, if a print plate has been exposed, has to enter into the decision, if a print job is started in a disposition module. Through the disposition of resources without capacity, the complete depiction of the workflow in the disposition module becomes possible.

In a further advantageous embodiment of a method according to the invention, process steps cannot be assigned to a resource in the disposition module. The “cutout” of particular process steps is useful in particular with respect to detail depth of the information, as it is realized in a known manner in JDF data structures for controlling the execution systems. The detailed presentation of a plurality of process steps, however, is often indispensable for the control system on the one hand, but for the disposition it is not only unnecessary, but also not useful, due to the high management and visualization effort involved. Through the possibility to cut such process steps out of the disposition, the method according to the invention allows a better overview of the process steps to be disposed, and reduces the overall effort required to dispose a job.

### EXEMPLARY EMBODIMENT

The invention will be subsequently described with reference to an embodiment. In a networked print shop jobs are managed through a management information system from receipt of an order until the delivery of the finished product. A job is defined by the calculation module of this management information system in Job Definition Format, and handed over to the disposition module, after release through the client, which disposes the particular process steps of the job to the various execution systems.

The disposition module internally uses a data structure, which is different from Job Definition Format, in particular, expanded for illustrating the workflow. For each process step, one or several process steps are defined respectively as predecessors or successors in the data structure, for the first process steps, a dummy process step “start” is defined as a predecessor, for the last process steps, a dummy “end” is defined as a successor. While the definition of the predecessors and successors of a particular job from a JDF data structure requires the examination of all nodes, the workflow in the data structure of the disposition module according to the invention is evident from the data, which are directly associated with the particular process step.

If a job is to be allocated in its particular process steps to execution systems through the disposition module, with respect to date, duration and volume (and other resources, like e.g. employees), a disposition is possible through the described data structure and through generally known methods critical path analysis, either forward, from the start point in time, or backward from the end point in time.

Furthermore, in the disposition module for each process step, a list of alphanumeric “group identifiers” is defined. The group identifier of all process steps of a newly identified group is set to the same value, according to default to a sequential number, but it can be redefined manually according to requirements.

The definition of groups can be considered in the disposition module, so that the process steps included in the group are performed in direct time sequence. The definition of groups additionally particularly simplifies the visualization of the workflow and the intuitive detection of the current status through the reduction of the elements to be displayed. The handling of the disposition module is also simplified significantly in comparison to known processes, since instead of a plurality of particular process steps for a group of process steps, quasi, like for a single process step, the allocation in the workflow can be adapted to changed requirements.

When loading the data from the calculation module into the disposition module, groups of process steps following each other directly are formed automatically, which process an incoming product further, in numbers between ten- and twenty thousand, which are being executed and painted on an execution system “machine A”, which require a processing time of less than three hours, and which are executed in the print mode “high quality print”, or which are processed in the format “50×70 cm” with a number of colors, which is larger than four. Within the groups, the process steps are initially sorted according to decreasing format, and in a secondary step according to increasing sheet number, and equipped with a sequential numeric identifier. This sequence of performing the process steps in a group can be manually changed through this identifier.

Further criteria for forming groups can be selected manually in the disposition module. Hereby, process steps are presorted according to resources. The selection of the possible rules is adapted according to the resources.

The “cutout” of particular process steps is useful, in particular, with respect to the detail depth of the information, as it is realized in JDF data structures for controlling execution systems in a known manner. The detailed description of a plurality of process steps, however, is often indispensable for the control system, but not only unnecessary for the business calculation, and in a similar manner for the disposition, but also not useful, due to the high effort for management and visualization. Through the possibility, to cut such process steps out from the disposition, the method according to the invention allows a better overview of process steps to be disposed, and reduces the overall effort required for the disposition of a job.

1. A method for the disposition of process steps in the context of jobs, which are issued by a management information system, and executed on at least one execution system, wherein the jobs are defined by a calculation module in the context of the management information system, volume and time resources of the execution systems are allocated by a disposition module, and transmitted to the execution systems in Job Definition Format,
characterized in that,
process steps are combined into groups in the disposition module.

2. A method according to claim 1,
characterized in that,
groups are dissolved in the disposition module, as required, and the resulting process steps are disposed one by one.

3. A method according to claim 1,
characterized in that,
a group is assembled in the context of a job, based on predefined rules.

4. A method according to claim 1,
characterized in that,
process steps of a group are sorted based on predefined rules.

5. A method according to claim 1,
characterized in that,
a group comprises similar process steps.

6. A method according to claim 1,
characterized in that,
groups are grouped in the disposition module.

7. A disposition module for a management information system,
wherein process steps of jobs, defined through a calculation module, can be transmitted to execution systems in Job Definition Format through a disposition module, and allocated to their resources,
characterized in that,
through the disposition module a method according to one of the preceding claims can be executed.

8. A disposition module according to claim 7,
characterized in that,
a group of process steps can be selectively allocated to resources, like a single process step.

9. A disposition module according to claim 8,
characterized in that,
a group of process steps can be visualized selectively, like a single process step.
